(19) United States
(12) Patent Application Publication
(10) Pub. No.: US 2014/0183217 A1
(43) Pub. Date: Jul. 3, 2014

(54) DISPENSING MECHANISM OF VENDING MACHINE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: CHEN-LIANG GENG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/011,956

(22) Filed: Aug. 28, 2013

(30) Foreign Application Priority Data
Dec. 28, 2012 (CN) 2012105822978

(51) Int. Cl. G07F 11/24

(52) U.S. Cl. CPC G07F 11/24
USPC 221/277

(57) ABSTRACT

A dispensing mechanism for a vending machine includes a first side plate, a second side plate, a bottom plate, and a rotary baffle. The second side plate and the first side plate cooperatively define a vertical space for accommodating items. The bottom plate is connected to a bottom edge of the first side plate and supports the items. The rotary baffle is located above the bottom plate and is rotatable about a horizontal axis. When item delivery is required, the rotary baffle moves through a predetermined angle to allow one item to be pushed through the rotary baffle and out by the weight of the remaining items in the vertical stack, which allows the delivery of purchased items individually.

### REFERENCE TO RELATED APPLICATIONS

This application claims all benefits accruing under 35 U.S.C. §119 from China Patent Application No. 201210582015.4 filed on Dec. 28, 2012 in the State Intellectual Property Office of China, the contents of the China Application are hereby incorporated by reference.

### BACKGROUND

1. Technical Field

The present disclosure generally relates to vending machines, and particularly relates to a dispensing mechanism of a vending machine.

2. Description of Related Art

Vending machines have been in common use for purchasing a variety of items such as snacks, beverages, alcohol, cigarettes, lottery tickets, cologne, consumer products and even gold and gems. A vending machine typically includes a dispensing mechanism for dispensing items to customers after the customers insert currency or credit into the vending machines. However, the conventional dispensing mechanism is inflexible and is not able to handle increasing demands.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a dispensing mechanism of a vending machine.

FIG. 2 is a cross-sectional view of the dispensing mechanism of FIG. 1.

FIG. 3 is similar to FIG. 1, showing the dispensing mechanism loaded with items.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

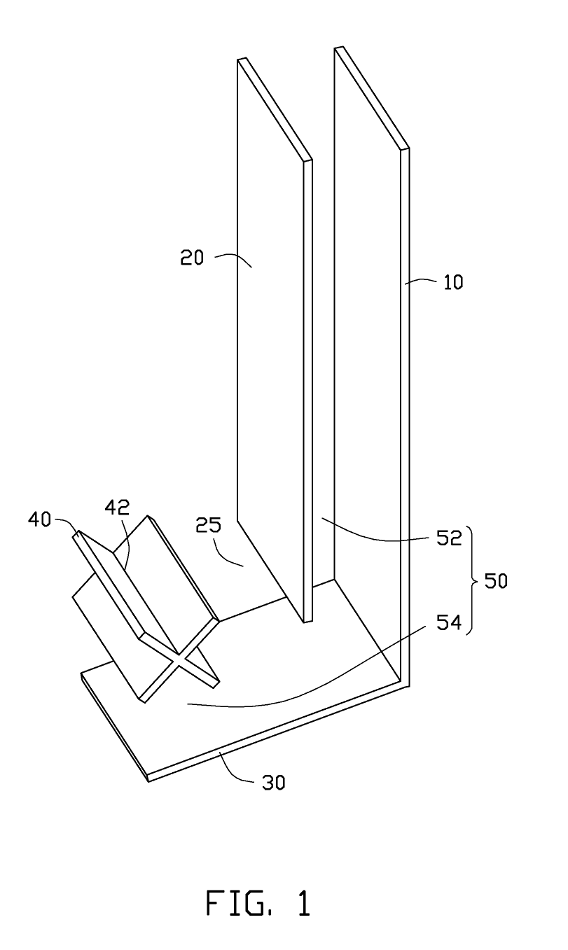

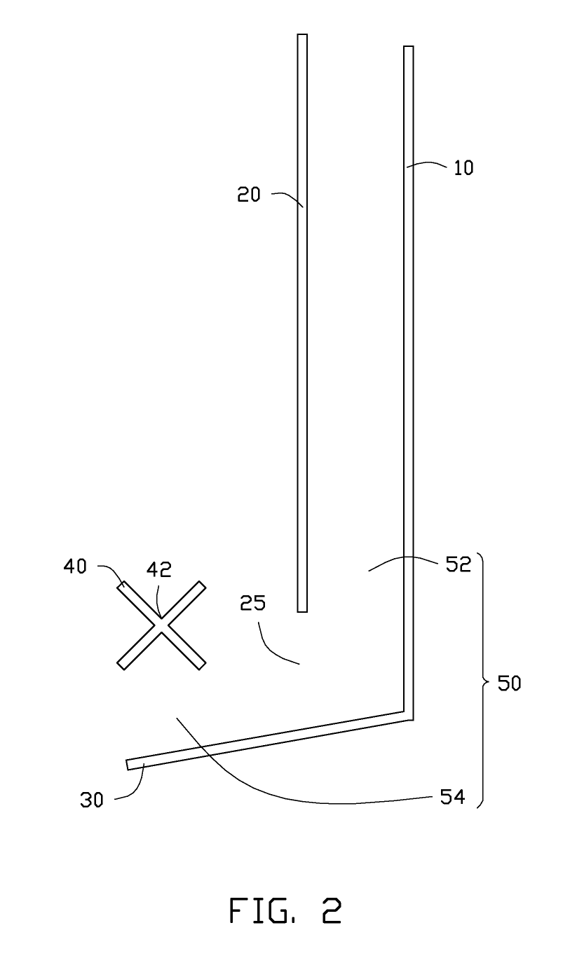

FIGS. 1 and 2 show an embodiment of a dispensing mechanism of a vending machine. The dispensing machine includes a first side plate 10, a second side plate 20, a bottom plate 30 and a rotary baffle 40.

The second side plate 20 is parallel to the first side plate 10. The second side plate 20 together with the first side plate 10 defines a vertical space 52 for accommodating items. A distance between the first side plate 10 and the second side plate 20 is substantially the same as a width of a item. A length of the second side plate 20 is smaller than that of the first side plate 10.

The bottom plate 30 is connected to a bottom edge of the first side plate 10. The bottom plate 30 extends obliquely and downwards from the bottom edge of the first side plate 10. The bottom plate 30 supports items. The bottom plate 30 together with the first side plate 10 forms an L-shaped structure. An obtuse angle is defined between the bottom plate 30 and the first side plate 10. In some embodiments, an angle between the bottom plate 30 and a horizontal plane is smaller than 30 degrees.

The bottom plate 30 is spaced from a bottom edge of the second side plate 20. An interspace 25 is defined between the bottom plate 30 and the bottom edge of the second side plate 20. A distance between the bottom plate 30 and the bottom edge of the second side plate 20 is substantially the same as a vertical height of an item.

The rotary baffle 40 is located above the bottom plate 30. The rotary baffle 40 is rotatable about a horizontal axis. The rotary baffle 40 defines a plurality of latching slots 42. Each of the plurality of latching slots 42 forms the shape of a V.

In one embodiment, as shown in FIG. 2, a cross section of the rotary baffle 40 is cross-shaped. The interior angle of each latching slot is then 90 degrees.

A horizontal space 54 above the bottom plate 30 and the vertical space 52 form an L-shaped aisle 50. The items may move along the L-shaped aisle 50 and drop down from the left edge of the bottom plate 30.

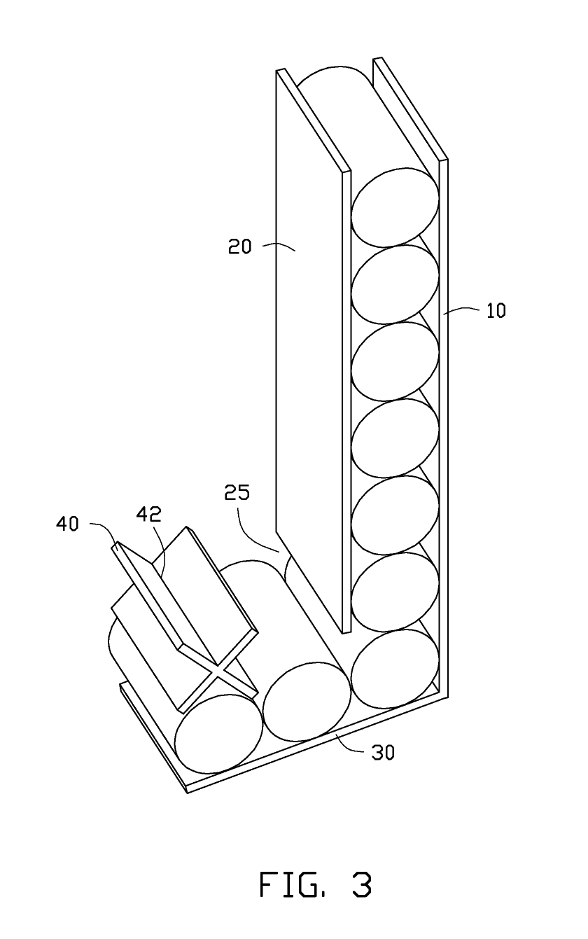

FIG. 3 shows that, in use, the dispensing mechanism is loaded with items. Some of the items are supported by the bottom plate 30 and others are accommodated in the vertical space 52. When the rotary baffle 40 is at rest, one of the plurality of latching slots 42 receives a item and prevents the items from moving away from the bottom plate 30. When the rotary baffle 40 rotates a predetermined angle (e.g. 90 degrees), the rotary baffle 40 allows one item to move away from the bottom plate 30. When a item has moved away from the bottom plate 30, the other items move down in the vertical space 52 by gravity and fill the position of the item which has moved away.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A dispensing mechanism of a vending machine, comprising:
a first side plate;
a second side plate parallel to the first side plate, the second side plate and the first side plate cooperatively defining a vertical space configured for accommodating items;
a bottom plate connected to a bottom edge of the first side plate and configured to support the items; and
a rotary baffle located above the bottom plate, the rotary baffle being rotatable about a horizontal axis, wherein the rotary baffle is configured to allow one of the items to move away from the bottom plate by rotating a predetermined angle at a time.

2. The dispensing mechanism of claim 1, wherein an obtuse angle is defined between the bottom plate and the first side plate.

3. The dispensing mechanism of claim 2, wherein the bottom plate is spaced from a bottom edge of the second side plate and an interspace is defined between the bottom plate and the bottom edge of the second side plate.

4. The dispensing mechanism of claim 3, wherein the rotary baffle defines a plurality of latching slots, when the rotary baffle is at rest, one of the plurality of latching slots latches one of the items and prevents the item from moving away from the bottom plate.

5. The dispensing mechanism of claim 4, wherein each of the plurality of latching slots is V-shaped.

6. The dispensing mechanism of claim 5, wherein a cross section of the rotary baffle is cross-shaped, the rotary baffle is configured to drive one of the items to move away from the bottom plate by rotating every 90 degrees.

7. The dispensing mechanism of claim 6, wherein an angle between the bottom plate and a horizontal plane is smaller than 30 degrees.

8. The dispensing mechanism of claim 6, wherein a distance between the first side plate and the second side plate is substantially the same as a width of one of the items.

9. The dispensing mechanism of claim 6, wherein a distance between the bottom plate and the bottom edge of the second side plate is substantially the same as a height of one of the items.

10. The dispensing mechanism of claim 6, wherein the bottom plate and the first side plate cooperatively form an L-shaped structure.

11. A dispensing mechanism of a vending machine, comprising:
a first side plate;
a second side plate parallel to the first side plate, the second side plate and with the first side plate cooperatively defining a vertical space configured for accommodating items;
a bottom plate extending obliquely and downwards from a bottom edge of the first side plate, the bottom plate being configured to support the items; and
a rotary baffle located above the bottom plate, the rotary baffle being rotatable about a horizontal axis, wherein when the rotary baffle is at rest, the rotary baffle retains the items and prevents the items from moving away from the bottom plate, when the rotary baffle rotates a predetermined angle, the rotary baffle allows one of the items to move away from the bottom plate.

12. The dispensing mechanism of claim 11, wherein an obtuse angle is defined between the bottom plate and the first side plate.

13. The dispensing mechanism of claim 12, wherein the bottom plate is spaced from a bottom edge of the second side plate and an interspace is defined between the bottom plate and the bottom edge of the second side plate.

14. The dispensing mechanism of claim 13, wherein the rotary baffle defines a plurality of latching slots, when the rotary baffle is at rest, one of the plurality of latching slots latches one of the items and prevents the item from moving away from the bottom plate.

15. The dispensing mechanism of claim 14, wherein each of the plurality of latching slots is V-shaped.

16. The dispensing mechanism of claim 15, wherein a cross section of the rotary baffle is cross-shaped, the rotary baffle is configured to drive one of the items to move away from the bottom plate by rotating every 90 degrees.

17. The dispensing mechanism of claim 16, wherein an angle between the bottom plate and a horizontal plane is smaller than 30 degrees.

18. The dispensing mechanism of claim 16, wherein a distance between the first side plate and the second side plate is substantially the same as a width of one of the items.

19. The dispensing mechanism of claim 16, wherein a distance between the bottom plate and the bottom edge of the second side plate is substantially the same as a height of one of the items.

20. The dispensing mechanism of claim 16, wherein the bottom plate and the first side plate cooperatively form an L-shaped structure.
